(19) United States
(12) Patent Application Publication
(10) Pub. No.: US 2011/0127697 A1
(43) Pub. Date: Jun. 2, 2011

(54) METHOD AND APPARATUS FOR CONTROLLING THE SIZE OF A LASER BEAM FOCAL SPOT

(76) Inventor: David Charles Milne, Enstone (GB)

(21) Appl. No.: 12/996,050

(22) PCT Filed: May 29, 2009
(86) PCT No.: PCT/GB09/01332

§ 371 Date: Dec. 3, 2010

(30) Foreign Application Priority Data
Jun. 3, 2008 (GB) 0810077.8

(51) Int. Cl. B29C 35/08; G02B 27/09; G02B 15/14; G02B 7/09

(52) U.S. Cl. 264/400; 359/676; 359/698

(57) ABSTRACT

A method and apparatus is described that allows the width of fine line structures ablated or cured by a focussed laser beam on the surface of flat substrates to be dynamically changed while the beam is in motion over the substrate surface while simultaneously maintaining the beam focal point accurately on the surface. A three-component variable optical telescope is used to independently control the beam diameter and collimation by movement of first and second optical components relative to the third optical component. The method allows different focal spot diameters and different ablated or cured line widths to be rapidly selected and ensures that the beam shape in the focal spot remains constant and the depth of focus is always maximized.

### TECHNICAL FIELD

This invention relates to controlling the size of a laser beam focal spot formed on a substrate, e.g. for ablation or laser curing of materials by direct writing methods. The invention is particularly appropriate for the high resolution, fine line patterning of thin films or layers of materials on thin glass, polymer, metal or other substrates that vary in thickness or are not flat.

### BACKGROUND ART

Techniques for using lasers to ablate or cure fine line structures in or on the surface of flat substrates are well known and many different arrangements for carrying out these operations are used. The common features of the equipment used are: a laser system emitting a pulsed or continuous beam, a focussing lens to concentrate the laser beam to a spot on the surface of the substrate and a method for moving the laser focal spot over the surface of the substrate.

The width of the line structure ablated or cured in the surface of the material on the substrate depends on the diameter of the laser spot formed on the surface. There is frequently a requirement to vary the width of the ablated or cured line during laser processing and hence it is necessary to change the diameter of the spot on the surface during the laser process procedure. In some cases it is even desirable to change the spot size while the beam is actually moving over the substrate surface.

The simplest way to change the spot size on the substrate surface is to change its position with respect to the beam focus. Since the diameter of the laser beam reduces as it propagates from the lens to the beam focus and expands beyond that point so movement of the substrate surface towards or away from the lens along the beam in either direction each side of focus causes an increase in spot size. Hence, the width of the ablated or cured line can be readily changed by relative movement of the substrate with respect to the beam focus.

Several methods are used to cause the beam focus to move with respect to the substrate surface. The simplest method is based on changing the distance of the focussing lens from the substrate either by moving the focussing lens or the substrate in a direction parallel to the beam axis by means of a servo motor driven stage. A more complex but faster method maintains the distance of the substrate from the lens fixed and changes the plane of the focal spot by causing the laser beam before the lens to converge or diverge by means of a servo motor driven, two-component, variable beam telescope. The latter method for causing the beam focus to move axially is commonly used with one or two axis beam scanners when used with either pre or post scanner lens systems for laser processing on flat substrates in order to correct for the curvature of the focal plane across the scan field.

The methods discussed above for line width control where the focus is moved with respect to the substrate surface are simple and effective but suffer from some problems as, when laser processing, it is often desirable to maintain the substrate at the exact focus of the beam. At this plane, the beam shape and the power or energy density profile are well defined and the distance over which the laser spot size changes, the depth of focus, is maximized. At points before or beyond the focal plane the beam shape is often no longer round and the power and energy density profiles cease to have a Gaussian distribution. In addition, the variation in beam size, and hence the variation in peak and average power and energy density, is a strong function of the distance along the beam so lack of flatness of the substrate over the process area becomes much more significant.

Another way to vary the size of the spot created at the focus of a lens is to vary the diameter of the beam before the lens. The diameter of the focal spot depends on the product of the focal length of the lens and the divergence of the laser beam and since the divergence is inversely dependent on the beam diameter so an increase in input beam size will cause a corresponding reduction in the diameter of the focal spot. Conversely, a decrease in input beam diameter causes a corresponding increase in focal spot diameter.

Changing the beam diameter entering the lens is relatively straightforward and is often achieved by using a simple 2 component beam telescope placed immediately after the laser output. There are problems with this method, however, unless the distance from the telescope to the lens is extremely large. As the collimation of the beam is changed, as well as changing the beam size at the lens, and hence the focal spot diameter, there is a movement of the focal spot along the beam direction, (as discussed above in the context of a method for moving the focal spot axially).

Hence, there remains a need to vary the diameter of the laser focal spot during a laser process whilst, at the same time, keeping the focal spot accurately positioned on the surface of a flat or non-flat substrate in order to retain the maximum depth of focus possible. The present invention seeks to address this need.

### DISCLOSURE OF INVENTION

According to a first aspect of the invention, there is provided apparatus for controlling the size of a laser beam focal spot formed on a substrate comprising:
a. a laser unit;
b. a variable optical telescope unit for independently changing the diameter and collimation of a laser beam received from the laser unit and comprising at least first, second and third optical components, the first and second optical components being movable relative to the third optical component so as to independently vary the distance between the third optical component and the first and second optical components;
c. a focussing lens for bringing the laser beam received from the variable optical telescope unit to a focus on the surface of a substrate;
d. a distance sensor for measuring the distance between the focussing lens and the surface of the substrate; and
e. a control system for controlling the movement of said first and second optical components in dependence upon an output of the distance sensor to independently vary the diameter and collimation of the laser beam received by the focussing lens whereby the diameter of the focus formed by the focussing lens can be controlled and its axial position (along the optic axis) can also be controlled so the focal spot is maintained on the surface of the substrate.

According to a second aspect of the invention, there is provided a method of controlling the size of a laser beam focal spot formed on a substrate comprising:
a. passing a laser beam through a variable optical telescope comprising at least first, second and third optical components, moving the first and second optical components relative to the third optical component so as to independently vary the distance between the third optical component and the first and second optical components thereby independently changing the diameter and collimation of the laser beam;
   passing the laser beam from the variable optical telescope through a focussing lens to bring the laser beam to a focus on the surface of a substrate;
b. measuring the distance between the focussing lens and the surface of the substrate; and
c. controlling the movement of said first and second optical components in dependence upon said distance so as to independently vary the diameter and collimation of the laser beam received by the focussing lens whereby the diameter of the focus formed by the focussing lens can be controlled and its axial position (along the optic axis) can also be controlled so the focal spot is maintained on the surface of the substrate

In order to be able vary the diameter of a laser focal spot and simultaneously keep the focal spot accurately positioned .on a surface it is necessary to be able to independently change both the beam diameter and its collimation at the focussing lens. This is achieved by passing the laser beam through a transmissive type optical telescope having at least first, second and third optical components situated before the focussing lens. By independent movement of at least two of the optical components in the telescope, the output beam diameter and collimation can be independently controlled. Such a system can be used to change the diameter of the focal spot and at the same time allow the distance of the focal spot from the lens to be controlled such as to maintain the focal spot on the surface of a substrate that is not flat or varies in thickness.

Such dual function beam expansion telescopes are known and are commercially available but these are usually manually adjusted. In some cases, motor driven units are available allowing remote operation.

To enable changes in beam diameter and collimation to take place rapidly so that the corresponding changes to focal spot diameters and focal spot axial locations required by a direct write laser process can be made either continuously or step wise during the processing of a substrate, all moveable optical components in the telescope are preferably servo motor driven and able to move very rapidly and accurately with independent control.

There are many possible designs for optical telescope systems involving at least first, second and third optical components that can achieve the necessary control of output beam expansion and collimation but the simplest and most compact (ie shortest) design for an optical telescope that can both expand the beam and vary the degree of collimation of the output beam has three components. Two of the optical components may be lenses with a negative power that cause an input beam to diverge and the third component is a lens with a positive power that causes an input beam to converge. The first component seen by the input beam is one of the negative lenses. The other two lenses can be placed in either order depending on the particular design.

An important requirement for such a variable three-component telescope is that the separation between the three components can be changed. This can be achieved by moving any two of the three lenses. Either the centre component can be fixed and the first and third components moved relative to it or either of the first or third components can be fixed and the other two components moved relative thereto. An arrangement that is mechanically convenient has the first component fixed and servo motor driven systems that vary the separation between both second and third lenses while at the same time moving both lenses closer to or further from the first lens.

Preferably, the servo motors are driven by an appropriate controller that receives information about the laser spot diameter required by the laser process from a master controller and this master controller also drives the motors that cause relative motion of the beam with respect to the substrate in two axes. In this way the moveable optical components in the telescope are automatically driven to the correct positions so that at any point on a flat two dimensional substrate the laser beam is caused to focus on the surface and the laser spot diameter is defined.

Since substrates are rarely perfectly flat and often vary in thickness, a sensor system is preferably provided to collect and record information about the relative distances of the substrate surface from the lens, compared to a reference distance, over the area that is required to be laser processed. A non contacting optical distance sensor attached to the focussing lens that probes the substrate surface close to the centre of the lens field is suitable for this application. Information about the substrate surface height is either obtained by mapping the process area before laser processing with this information then used to adjust the position of the optical components in the telescope during processing. Alternatively, depending on the beam speed over the surface, height information is gathered during laser beam movement and this is used to continuously update the controller that operates the telescope component servo motors to maintain the focus on the substrate surface.

Direct write motion of the beam with respect to the substrate can be achieved by several methods all of which can be used. In the simplest case the focussing lens is stationary and the substrate is moved in two axes on a pair of orthogonal servo motor driven stages. In a more complex case, the substrate is held stationary and the focussing lens is moved in two axes on servo motor driven stages mounted on gantries over the substrate. An intermediate case, that is often used has the substrate moving in one axis and the focussing lens moving in the other on a gantry over the substrate.

For higher direct write beam speeds, one or two axis beam scanner units are used. These can be used with a suitable focussing lens placed either before or after the scanner and can also be combined with linear stages to allow operation in step and scan mode.

The method described thus enables the size of a moving laser beam focal spot on a substrate surface to be dynamically changed in order to control the width of an ablated or cured line pattern while at the same time maintaining a large depth of focus.

### BRIEF DESCRIPTION OF DRAWINGS

The invention will now be further described, merely by way of example, with reference to the accompanying drawings, in which:

FIG. 1 is a schematic diagram of a typical laser direct write optical system;

FIG. 2 shows details of the lens focal plane for a large diameter input beam in such a system;

FIG. 3 shows details of the lens focal plane for a smaller diameter input beam in such a system;

FIG. 4 is a schematic diagram of one type of 3-component telescope for use in such a system;

FIG. 5 is a schematic diagram of a second type of 3-component telescope for use in such a system;

FIG. 6 is a schematic diagram of a third type of 3-component telescope for use in such a system;

FIG. 7 illustrates the positions for the moveable components in such 3-component telescopes for three different beam expansion ratios;

FIG. 8 is a schematic diagram of a first embodiment of apparatus for implementing the invention; and

FIG. 9 is a schematic diagram of a second embodiment of apparatus for implementing the invention.

### DETAILED DESCRIPTION OF DRAWINGS

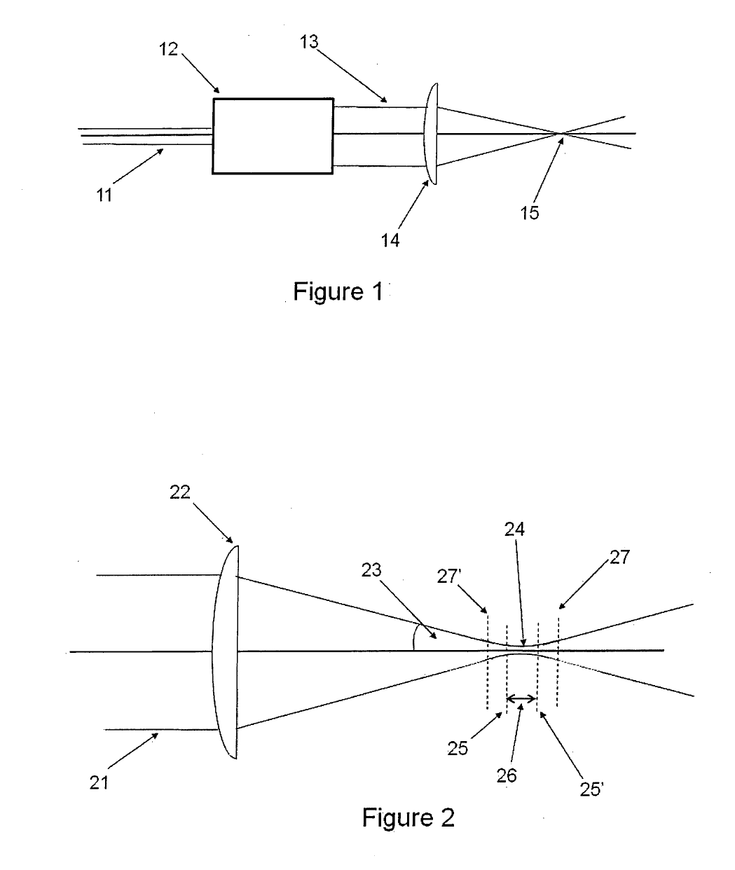

FIG. 1

FIG. 1 shows a standard method by which a laser beam is conditioned for direct write laser processing. An input laser beam 11, generally of small diameter, passes into a transmissive beam expansion telescope 12 and emerges as a beam of larger diameter 13. Lens 14 then focuses the beam 13 to a small focal spot 15 whose diameter and distance from the lens 14 are functions of the laser beam 13 diameter and collimation, respectively.

FIG. 2

FIG. 2 show details of the laser beam in the vicinity of the focal spot. A beam 21 is focussed by a lens 22 so that it converges with half angle 23 to a beam waist or focus 24 before expanding. For the case where the beam entering the focussing lens 22 is collimated, the minimum diameter (d) of the beam in the waist region 24 is a function of the laser wavelength (λ), the quality (M2) of the laser beam relative to a perfect diffraction limited beam, the laser beam 21 diameter (D) and the focal length (f) of the lens. The focal spot diameter (d) varies linearly with focal length (f) and inversely with beam diameter (D) so that a convenient measure of the focal spot diameter (d) for any lens and laser beam diameter is the so called numerical aperture (NA) which is defined as the sine of the half angle of beam convergence (θ) and hence;

NA=sin θ=sin (tan⁻¹(D/2f).

For most practical cases this can be approximated by:

NA=D/2f.

The minimum focal spot diameter (d) can thus be calculated using the following formula (that is well known to those in the art):

d=0.6×M2×λ/NA.

As an example, for the case of a close to diffraction limited laser beam with an M2 of 1.2 and a diameter of 10 mm focussed by a lens with a focal length of 100 mm, the NA is approximately 0.05 and the minimum focal spot diameter is close to 5 μm and 15 μm for laser wavelengths of 0.355 μm and 1.064 μm, respectively.

The beam waist or focus extends over a finite axial distance 26 between planes 25, 25′. In terms of laser processing, the length 26 of the beam waist region or depth of focus is critical as this is the distance over which there little change in focal spot diameter and the power or energy distribution is well defined. The depth of focus (DoF) can be calculated using the following formula (that is well known to those in the art):

DoF=λ/M2×NA²

so that, for the examples given above, depths of focus of almost 120 μm and 360 μm are realized for wavelengths of 0.355 μm and 1.064 μm, respectively.

FIG. 2 also shows how the beam diameter increases rapidly at planes 27 and 27′ beyond and before the beam waist region 24. In this case, the increase in beam size depends on the NA of the beam and the change in diameter (ΔD) caused by an axial displacement (Δx) along the beam path is given approximately by:

ΔD=2×NA×Δx

For the above example, where the NA is 0.05, ΔD=0.1×Δx so that for a wavelength of 0.355 μm, a movement of only 50 μm along the beam path before or beyond the depth of focus increases the diameter by 5 μm which means the beam has approximately doubled in diameter and the power or energy density reduced by a factor of about four. For the case where the wavelength is 1.064 μm, a movement of only 150 μm along the beam path beyond the depth of focus increases the diameter by 15 μm which means the beam has again approximately doubled in diameter and the power or energy density reduced by a factor of about four. Hence, in both these cases, a movement of less than half the depth of focus leads to a doubling of the spot size. A movement equal to the depth of focus leads to almost trebling of the spot size. These effects should be contrasted to the constancy of the spot size over the depth of focus and show the importance (from a process control point of view) of operating with the focus of the beam situated on the substrate surface.

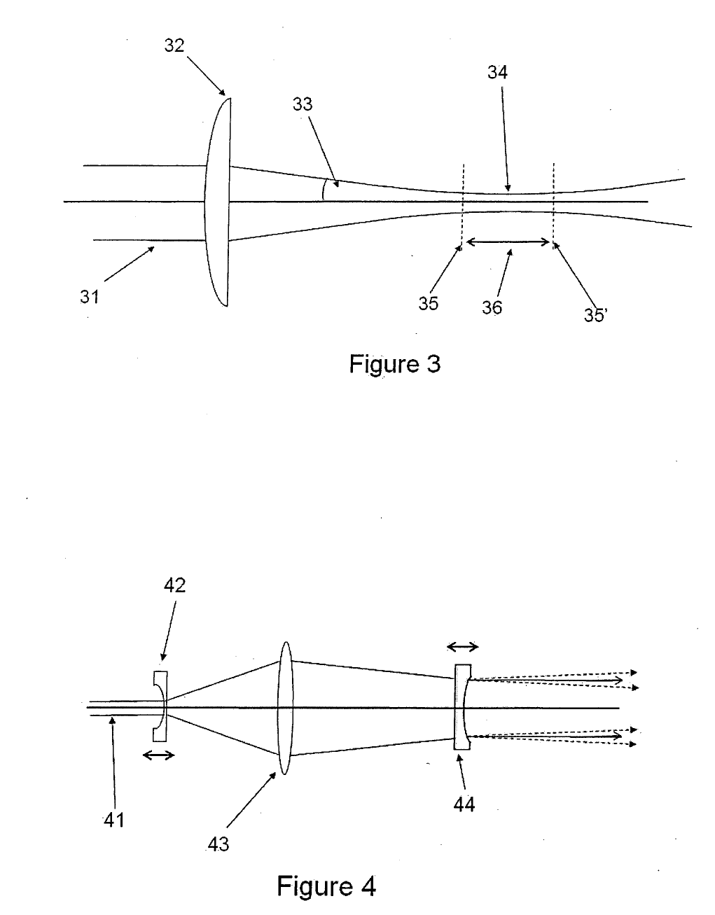

FIG. 3

FIG. 3 shows details of the laser beam in the vicinity of the focal spot for the case where the input beam is reduced in diameter compared to FIG. 2. A beam 31 is focussed by a lens 32 so that it converges with half angle 33 to a beam waist or focus 34 before expanding. Because of the smaller numerical aperture of the beam, the minimum spot size achieved at focus is larger than the case shown in FIG. 2. In addition, because of the lower beam convergence or numerical aperture of the beam, the distance 36 over which the diameter stays roughly constant (between planes 35 and 35′), or depth of focus, is considerably longer than the case shown in FIG. 2.

For the examples discussed above of a close to diffraction limited laser beam with an M2 of 1.2 focussed by a lens with a focal length of 100 mm but with a diameter reduced by a factor of two to 5 mm, the NA is approximately 0.025 and the minimum focal spot diameter increases by a factor of two to 10 μm and 30 μm for wavelengths of 0.355 μm and 1.064 μm, respectively. The depths of focus in these cases increases by a factor of four to almost 0.5 mm and 1.5 mmm for wavelengths of 0.355 μm and 1.064 μm, respectively.

Comparing FIGS. 2 and 3 shows the advantages that can be achieved in terms of enhanced depth of focus and process latitude by operating with the focus always on the substrate surface and changing focal spot size by adjusting the focussing lens input beam diameter. For example, if a 10 μm wide feature is required to be ablated or exposed using a 355 nm, M2=1.2 laser and the 100 mm focal length lens discussed above, then the required spot size can be formed using a 5 mm input beam having an NA of 0.025. In this case, the process is very tolerant to substrate non flatness as the depth of focus is almost 0.5 mm. On the other hand, if the input beam is larger, e.g. at 10 mm diameter, in order to achieve a 10 μm diameter laser spot the substrate has to be displaced with respect to the focal plane and placed in a region of the beam where it is converging or diverging. In these positions, the required spot size can be achieved but to hold it to this value with a variation of less than +/−10% requires the distance between the lens and the substrate surface to be held constant to within +/−10 μm. In practice, this would be very difficult to achieve. This example illustrates clearly the value of operating with the laser focal spot positioned on the surface of the substrate.

FIG. 4

FIG. 4 shows one type of three-lens beam expander telescope in which a positive (converging) lens is fixed in position and is positioned between the two negative (diverging) lenses that can each move along the beam axis. A small diameter input beam 41 is caused to diverge by negative lens 42. The expanding beam intercepts positive lens 43 which causes the beam to converge. Output negative lens 44 diverges the beam to give an output that is larger than the input beam and is either collimated, as shown, or is converging or diverging depending on the locations of the first and third lenses 42, 44 with respect to the second one lens 43. For simplicity, the three lenses shown in the figure are indicated as simple singlets but, in practice, it is likely that one or more of them will comprise more than one element in order to provide satisfactory optical . performance. The first and third lenses 42, 44 need to be able to move rapidly along the optical axis. This is best achieved by mounting them both on carriages on stages (not shown) running parallel to the optical axis. The carriages are driven by linear servo motors or by rotary servo motors via leadscrews. Encoders are fitted to give position information for the servo control system. The figure shows the first and third lenses 42, 44 as moveable and the second lens 43 fixed but, in practice, any two of the three lenses can move to achieve the necessary control of beam expansion and collimation.

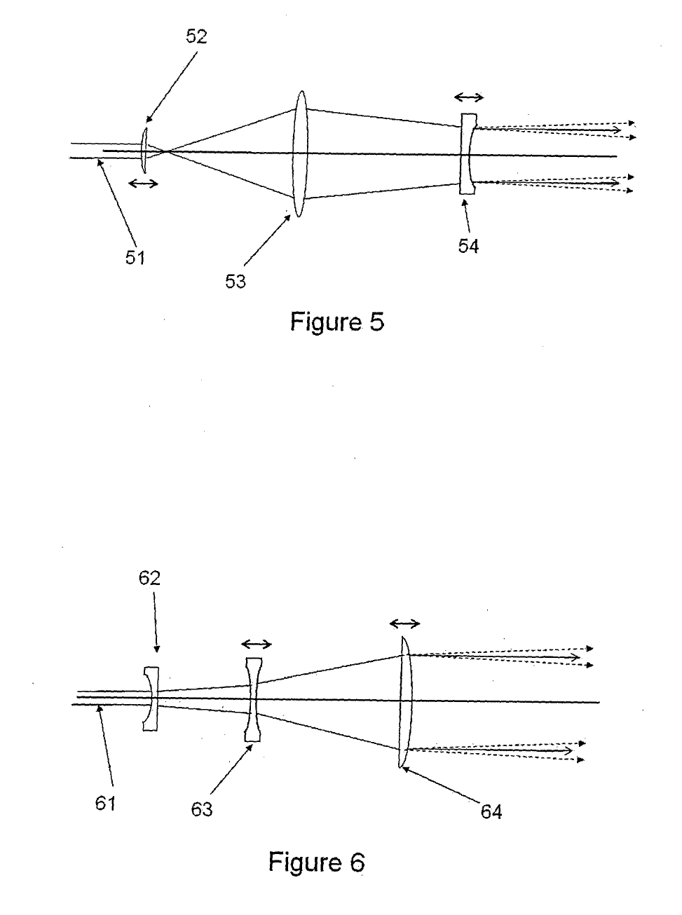

FIG. 5

FIG. 5 shows a variation of the three lens beam expander telescope shown in FIG. 4 in which the first negative lens is replaced by a positive lens. This type of optical telescope is less compact (ie longer) than one using a first component that has negative power but functions to provide the necessary control of beam expansion and collimation. A small diameter input beam 51 is caused to converge by positive lens 52. After passing through a focus, the expanding beam is intercepted by the second positive lens 53 which causes the expanding beam to converge. Output negative lens 54 diverges the beam to give an output that is larger than the input beam and is either collimated, as shown, or is converging or diverging depending on the separations between the lenses. As in FIG. 4, the three lenses are indicated as simple singlets but in practice may be more complex. The figure shows the first and third lenses 52, 54 as moveable but, in practice, any two of the three lenses can move to achieve the necessary control of beam expansion and collimation. The required movement can be achieved by mounting the two moveable lenses on independent servo motor driven carriages on stages running parallel to the optical axis.

FIG. 6

FIG. 6 shows another type of three lens beam expander telescope where the positive lens is the last component and is preceded by two negative lenses. The first lens is fixed in position and the second and third lenses can move along the beam axis. A small diameter input beam 61 is caused to diverge by negative lens 62. The expanding beam is intercepted by the second negative lens 63 which causes the beam to diverge further. Output positive lens 64 converges the beam to give an output that is larger than the input beam and is either collimated, as shown, or is converging or diverging depending on the locations of the second and third lenses 63, 64 with respect to the first lens 62. As in previous figures, the three lenses are indicated as simple singlets but in practice may be more complex. The figure shows the second and third lenses 63, 64 as moveable but, in practice, any two of the three lenses can move to achieve the necessary control of beam expansion and collimation. The required lens movements can be achieved by mounting the two moveable lenses on independent servo motor driven carriages on stages running parallel to the optical axis. Alternatively, the second lens 63 can be mounted on a first servo motor driven stage to allow movement with respect to the first lens 62 with the third lens 64 mounted on a second servo driven stage mounted on the first stage to allow movement with respect to the second lens 63

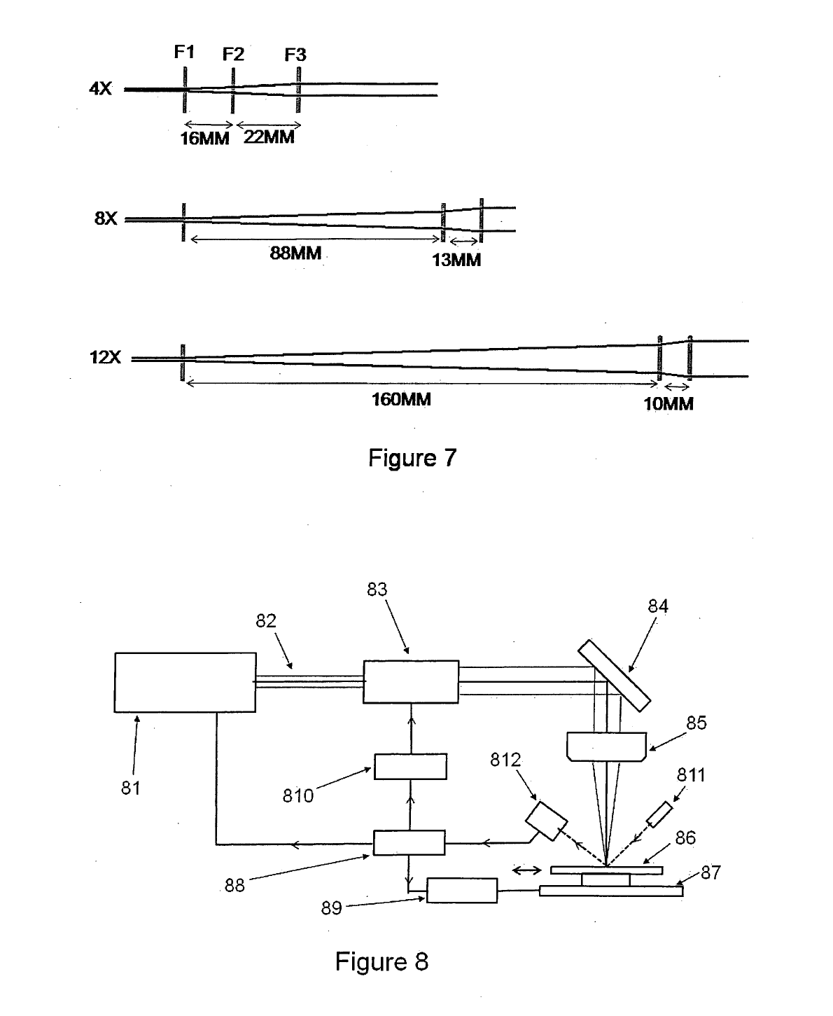

FIG. 7

FIG. 7 illustrates an example of the positions of the lenses for different beam expansions for a compact telescope of the type shown in FIG. 6 where two negative lenses precede an output positive lens and the first negative lens is fixed and the second and third lenses are moveable. In the example shown, the following focal lengths are used; first lens (f1)=−20 mm, second lens (f2)=−36 mm and third lens (f3)=40 mm. The example shows the different positions of the second and third lenses F1, F3, with respect to the first, that are required to achieve beam expansion ratios from four to twelve. Such a threefold change in output beam diameter allows a threefold variation in the diameter of the focal spot at the focus of a following laser focussing lens which is generally sufficient for most direct write laser applications as this leads to almost an order of magnitude change in power or energy density in the spot. The example also shows that, for this type of telescope arrangement, over the range of beam expansion ratios shown, the change of separation between the second and third lenses F2, F3 is much less than between the first and third lenses F1, F3. For the case shown, the change of separation between the second and third lenses F2, F3 is 12 mm (from 22 mm to 10 mm) whereas the change between the first and second lenses F1, F2 is 144 mm (16 mm to 160 mm). From the figure, it is also possible to see that relative movement between the first and second lenses F1, F2 is the primary factor in setting the degree of beam expansion whereas relative motion between the second and third lenses F2, F3 is the primary factor in controlling the collimation of the output beam. This geometry of telescope lends itself readily to a motion control system where a high speed, short travel stage is used to vary the separation between the last two components and this complete assembly is mounted on a second stage with longer travel to vary the separation between the first two components. Such an arrangement allows very rapid changes in the collimation of the output beam so that the focal spot can be moved axially to follow an irregular substrate surface and slower speed changes in beam diameter to allow change of focal spot diameter.

FIG. 8

FIG. 8 shows a first embodiment of apparatus that is suitable for implementing the arrangement described above. Laser unit 81 emits a beam 82 of small diameter which is passed through a servo motor controlled, three-component telescope 83, e.g. of the type shown in FIG. 4, 5 or 6, which increases the diameter of the beam and controls its collimation. The beam then passes via a turning mirror 84 to a focussing lens 85. The lens 85 focuses the beam onto the surface of a substrate 86 mounted on a pair of orthogonal servo motor driven linear stages 87. The stages 87 move the substrate 86 in two dimensions in a plane perpendicular to the laser beam so that the laser focal spot can be moved over the full area of the substrate 86. A master control computer 88 sends appropriate signals to the laser 81 to control the power, energy or repetition rate, to the stage controller 89 to move the substrate in two axes and to a telescope control unit 810 to control the diameter and collimation of the beam entering the focussing lens 85. In this way, the system is able to perform a variety of direct write laser processes on the surface of a flat substrate 86 with the laser spot size and laser power (or other laser parameters) being changed continuously or intermittently during the process as required. For the case where substrate is not flat, a substrate surface height sensor is attached to the lens mount to record changes in the distance of the substrate surface 86 from the lens 85. Many different types of substrate height sensor are available using optical, mechanical, ultrasonic or electrical distance measurement methods. In the figure, an optical height sensor is shown. Laser diode unit 811 directs a beam to the substrate surface 86 close to the beam focus position. Laser diode radiation reflected or scattered from the substrate surface 86 is collected by sensor unit 812. This unit images the laser diode spot on the substrate surface 86 onto a linear position detector or 2D optical sensor such as a CCD camera. As the distance of the substrate surface 86 from the lens 85 changes, so the position of the imaged spot on the sensor 812 moves and a signal is generated that is related to the substrate to lens distance. This data is passed to the master computer 88 where it is processed and then passed to the telescope control unit 810 to effect a change to the moveable components in the telescope 83. In this way, the system is able to perform direct write laser processes on the surface of substrates 86 that are not flat with the laser focal spot maintained accurately on the surface at all times during the process. Focal spot size and laser power (or other laser parameters) can also be changed continuously or intermittently during the process as required.

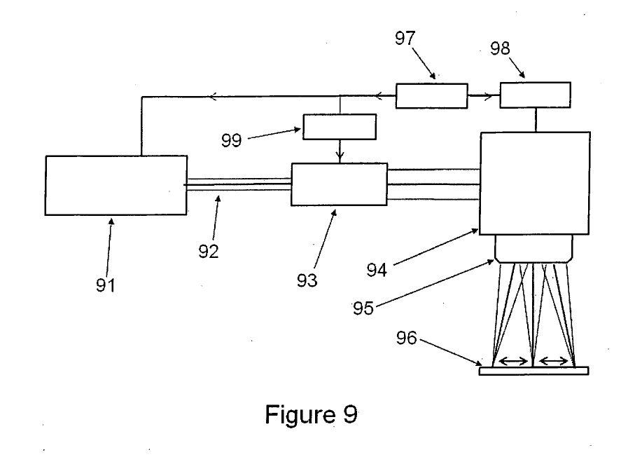

FIG. 9

FIG. 9 shows a second embodiment of apparatus that is suitable for implementing the arrangement described above. Laser unit 91 emits a beam 92 of small diameter which is passed through a servo motor controlled, three-component telescope 93, of the type shown in FIG. 4, 5 or 6, which increases the diameter of the beam and controls its collimation. The beam passes into a two axis beam scanner unit 94 and then through a scanning focussing lens 95. The lens 95 focuses the beam onto the surface of a substrate 96. The two axis beam scanner unit 94 moves the focal spot in two dimensions over all or part of the area of the substrate 96. A master control computer 97 sends appropriate signals to the laser 91 to control the power, energy or repetition rate, to the scanner controller 98 to move the beam in two axes and to a telescope control unit 99 to control the diameter and collimation of the beam entering the focussing lens 95. In this way, the system is able to perform a variety of direct write laser processes on the surface of a flat substrate 95 with the laser spot size and laser power or other laser parameters being changed continuously or intermittently during the process as required. For substrates that are larger than the scan field of the lens 95, the substrate 96 can be mounted on linear stages (as shown in FIG. 8) and the full substrate area processed in step and scan mode. For the case where the substrate is not flat, a substrate surface height sensor can be attached to the lens mount to record changes in the distance of the substrate surface 96 from the lens 95 and feed this information into the system controller 97 to allow telescope and beam collimation changes to be made (this height sensor is not shown in the FIG. 9). With such a sensor, the system is able to perform direct write, step and scan laser processes on the surface of substrates that are not flat with the laser focal spot moved axially to maintain focus accurately on the surface of each scan area.

The arrangement described above thus provides a method for directly writing line structures with varying widths, or several different defined widths, by means of a moving focused laser beam on the surface of a discrete substrate in a single continuous or step wise process operation by laser ablating or curing a material on the substrate by dynamically changing the diameter and collimation of the laser beam so that the focal spot changes in size and remains located on the substrate surface at all times in order to achieve maximum depth of focus and where the substrate surface may vary in distance from the focussing lens, such method consisting of:
a. guiding a laser beam along an optical axis;
b. placing a transmissive optical telescope system on the optical axis the telescope consisting of at least 3 optical elements where at least two of the elements are independently movable along the optical axis by means of servo motors;
c. placing a laser beam focussing lens on the optical axis after the optical telescope;
d. placing a substrate as normal to the optical axis as possible and as close to the nominal focal plane of the focussing lens as possible;
e. adjusting the positions of the moveable components in the telescope to set the laser focal spot to have a first diameter and be accurately located on the surface of the substrate;
f. ablating or curing a line structure with a width of a first value in the material on the surface of the substrate by causing relative motion of the focal spot with respect to the substrate in the plane normal to the optical axis;
g. during motion of the beam with respect to the substrate, or at intervals after a period of motion, changing the position of the moveable components in the telescope in order to change the diameter and collimation of the laser beam passing through the lens in order to change the diameter of the focal spot to a different size in order to change the width of the line structure ablated or cured in the substrate to a different defined value and also maintain the position of the focal spot on the surface of the substrate;
h. periodically measuring the distance of the substrate surface from the focussing lens and using that data to change the position of the moveable components in the telescope in order to maintain the position of the focal spot on the substrate surface while maintaining constant the focal spot diameter and the corresponding width of the line structure ablated or cured in the substrate;

The arrangement described provides apparatus for carrying out this method comprising:
a. a laser unit;
b. a servo motor controlled variable optical telescope unit;
c. a laser beam focussing lens;
d. a device for measuring the distance of the substrate surface from the focussing lens; and
e. a fast control system that links the movement of the adjustable components in the telescope to the position of the laser focal spot on the substrate surface and the distance of the substrate surface at that position from the focussing lens.

1. Apparatus for controlling the size of a laser beam focal spot formed on a substrate comprising:
a. a laser unit;
b. a variable optical telescope unit for independently changing the diameter and collimation of a laser beam received from the laser unit and comprising at least first, second and third optical components, the first and second optical components being movable relative to the third optical component so as to independently vary the distance between the third optical component and the first and second optical components;
c. a focussing lens for bringing the laser beam received from the variable optical telescope unit to a focus on the surface of a substrate;
d. a distance sensor for measuring the distance between the focussing lens and the surface of the substrate; and
e. a control system for controlling the movement of said first and second optical components in dependence upon an output of the distance sensor to independently vary the diameter and collimation of the laser beam received by the focussing lens whereby the diameter of the focus formed by the focussing lens can be controlled and its axial position (along the optic axis) can also be controlled so the focal spot is maintained on the surface of the substrate.

2. Apparatus as claimed in claim 1 comprising servo motors for moving the first and second optical components relative to the third optical component.

3. Apparatus as claimed in claim 1 in which the third optical component is located between the first and second optical components.

4. Apparatus as claimed in claim 3 in which the third optical component comprises a converging lens (or a plurality of lens elements which, together, provide a converging component) and the first and second optical elements each comprise a diverging lens (or a plurality of lens elements which, together, provide a converging component).

5. Apparatus as claimed in claim 1 in which the third optical element is positioned to receive the laser beam from the laser unit and then transmit this to the second and then the first optical components, the third and second optical components each comprise a diverging lens (or a plurality of lens elements which, together, provide a diverging optical component) and the first optical component comprises a converging lens (or a plurality of lens elements which, together, provide a converging optical component).

6. Apparatus as claimed in claim 3 in which the third optical component is fixed and the first and second optical components are each moveable towards and away from the third optical element.

7. Apparatus as claimed in claim 6 comprising a scanner for scanning the laser beam focal spot over the surface of a substrate (or vice versa).

8. Apparatus as claimed in claim 7 in which the distance sensor is arranged to sense changes in the distance between the focussing lens and the surface of the substrate and provide this information to the control system so appropriate adjustments can be made to the variable optical telescope whereby the laser beam focal spot can be maintained accurately on the surface of a substrate.

9. Apparatus as claimed in claim 8 in which the control system is arranged to control the power, energy and/or repetition rate of the laser unit and to control movement of the first and second optical components so as to change the size of the laser beam focal spot and/or the laser power either continuously or intermittently whilst maintaining the laser beam focal spot accurately on the surface of the substrate.

10. A method of controlling the size of a laser beam focal spot formed on a substrate comprising:
a. passing a laser beam through a variable optical telescope comprising at least first, second and third optical components, moving the first and second optical components relative to the third optical component so as to independently vary the distance between the third optical component and the first and second optical components thereby independently changing the diameter and collimation of the laser beam;
b. passing the laser beam from the variable optical telescope through a focussing lens to bring the laser beam to a focus on the surface of a substrate;
c. measuring the distance between the focussing lens and the surface of the substrate; and
d. controlling the movement of said first and second optical ″ components in dependence upon said distance so as to independently vary the diameter and collimation of the laser beam received by the focussing lens whereby the diameter of the focus formed by the focussing lens can be controlled and its axial position (along the optic axis) can also be controlled so the focal spot is maintained on the surface of the substrate.

11. A method as claimed in claim 10 in which the size of the laser beam focal spot is controlled principally by changing the diameter of the laser beam output by the variable optical telescope unit.

12. A method as claimed in claim 10 in which the axial position (along the optic axis) of the focus formed by the focussing lens is controlled principally by changing the collimation of the laser beam output by the variable optical telescope unit.

13. A method as claimed in claim 10, in which the laser beam focal spot is scanned over the surface of the substrate and the positions of the first and second optical components are adjusted dynamically so as to change the size of the laser beam focal spot either continuously or intermittently.

14. A method as claimed in claim 13 in which a line structure of a first width is ablated or cured in the surface of the substrate, the positions of the first and second optical components are adjusted and a line structure of a second width is ablated or cured in the surface of the substrate, whilst maintaining the laser beam focal spot accordingly on the surface of the substrate.

15. A method as claimed in claim 10 in which changes in the distance between the focussing lens and the surface of the substrate are sensed and movement of the first and second optical components is controlled in dependence upon these changes so the laser beam focal spot can be accurately maintained on the surface of a substrate.
